(19) United States
(12) Patent Application Publication
(10) Pub. No.: US 2007/0280254 A1
(43) Pub. Date: Dec. 6, 2007

(54) Enhanced network communication

(75) Inventors: David Milstein, Redmond, WA (US); Kuansan Wang, Bellevue, WA (US); Linda Criddle, Kirkland, WA (US); Lon-Chan Chu, Redmond, WA (US); Michael D. Malueg, Renton, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/444,600

(22) Filed: May 31, 2006

(51) Int. Cl. H04L 12/56

(52) U.S. Cl. 370/395.2

(57) ABSTRACT

Aspects of the present invention are directed at software systems for sending a data item from a sending client to a receiving client. In accordance with one embodiment, software components are provided that include a command handling component and a processing component. The command handling component accepts event data when a command to send a data item is received. Then a request to present the data item is transmitted from the sending client to the receiving client. When the request is received, the processing component uses instructions transmitted from the sending client to cause the data item to be presented on the receiving client.

### BACKGROUND

Generally described, an Internet telephony system provides an opportunity for users to have a call connection with enhanced calling features compared to a conventional Public Switched Telephone Network (PSTN)-based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services which the traditional telephony technology has not been able to provide. For example, traditional telephony technology is typically limited to audio communications. However, it is generally acknowledged that significant amounts of information may be communicated that is non-verbal when individuals interact. In this regard, individuals involved in a “face-to-face” communication may make gestures, use various facial expressions, etc., each of which conveys information to parties involved in the communication. These and other types of non-verbal communications may not be communicated using traditional telephony technology.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

Aspects of the present invention are directed at software systems for sending a data item from a sending client to a receiving client. In accordance with one embodiment software components are provided that include a command handling component and a processing component. The command handling component accepts event data when a command to send a data item is received. Then, the processing component uses instructions transmitted from the sending client to cause the data item to be presented on the receiving client. As a result, data items that adhere to any number of different formats (e.g., text, audio, image, and/or procedure, etc.) may be transmitted concurrently with a call.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for establishing a conversation channel between various clients in accordance with an aspect of the present invention;

FIG. 2 is a block diagram illustrative of a VoIP client in accordance with an aspect of the present invention;

FIG. 3 is a block diagram illustrative of various components associated with a VoIP device in accordance with an aspect of the present invention;

FIGS. 4A and 4B are block diagrams illustrative of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIG. 7 is a block diagram illustrating interactions among various VoIP entities for collecting and transferring contextual information in accordance with an aspect of the present invention;

FIG. 8A and 8B are exemplary flow diagrams for transmitting and receiving a data item from a sending client to a receiving client; and

FIGS. 9-13 are block diagrams illustrative of various attribute and classes of structured hierarchies corresponding to VoIP contextual information in accordance with an aspect of the present invention.

### DETAILED DESCRIPTION

Aspects of the present invention are directed at a software system for transmitting a data item from a sending client to a receiving client. For example, a data item may be transmitted over a communication channel concurrently with call data to enhance the ways in which parties to the call may communicate. Although the present invention will be described in connection with an IP telephony environment, it is equally applicable to any type of digital data exchange that includes audio. Accordingly, the disclosed embodiments and examples are illustrative in nature and should not be construed as limiting.

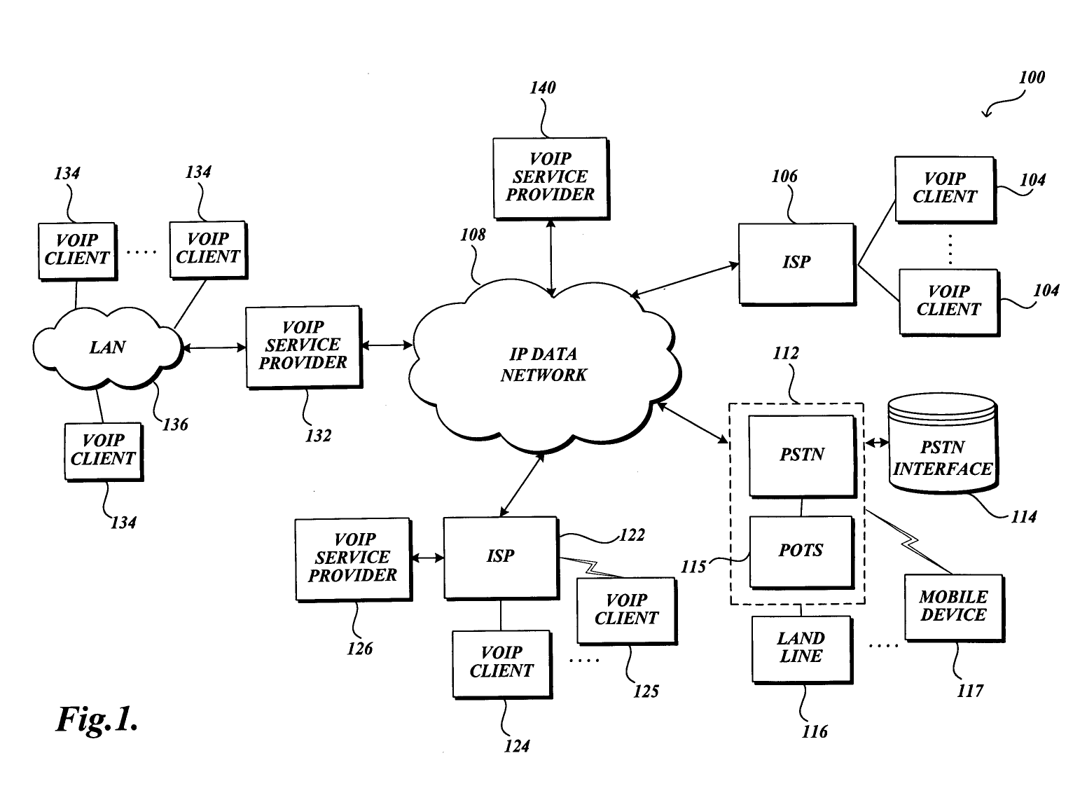

With reference to FIG. 1, a block diagram of an IP telephony environment 100 for providing IP telephone services between various “VoIP clients” is shown. A “VoIP client” or a “client,” as used herein, refers to a particular contact point, such as an individual, an organization, applications (“BOT”), gadget, or agent, a company, etc., one or more associated VoIP devices and a unique VoIP client identifier. For example, a single individual, five associated VoIP devices and a unique VoIP client identifier may collectively makeup a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live where each individual is associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108 such as the Internet, an intranet network, a wide area network (WAN), a local area network (LAN) and the like. The IP telephony environment 100 may further include VoIP service providers 126, 132 providing VoIP or other data exchange services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company). Moreover, the contextual information may include data items such as electronic documents, graphical representations, instructions for making the data items available on a client device, and/or data items for accessing functionality available from the client device.

The IP telephony environment 100 may also include third party VoIP service providers 140. The VoIP service providers 126, 132, 140 may provide various calling features, such as incoming call-filtering, text data, voice and media data integration, and the integrated data transmission as part of a VoIP call conversation. VoIP clients 104, 124, 125, 136 may create, maintain, and provide information relating to rules and preferences for receiving data items and exposing functionality provided from the client device. In addition, the VoIP service providers 126, 132, 140 may also generate, maintain, and provide a separated set of metadata information of various preferences that depend on the individual(s) in which a call connection has been established.

VoIP service providers 132 may be coupled to a private network such as a company LAN 136, providing IP telephone services (e.g., internal calls within the private network, external calls outside of the private network, and the like) and multimedia data services to several VoIP clients 134 communicatively connected to the company LAN 136. Similarly, VoIP service providers, such as VoIP service provider 126, may be coupled to Internet Service Provider (ISP) 122, providing IP telephone services and VoIP services for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with Plain Old Telephone Service (POTS) 115 via PSTN 112, or Private Branch exchange (PBX) 113. A PSTN interface 114 such as a PSTN gateway may provide access between POTS/PSTN and the IP data network 108. The PSTN interface 114 may translate VoIP data packets into circuit switched voice traffic for PSTN and vice versa. The PSTN 112 may include a land line device 116, a mobile device 117, and the like.

Conventional voice devices, such as land line 116 may request a connection with the VoIP client and an appropriate VoIP device associated with the VoIP client will be selected to establish a call connection with the conventional voice devices. In one example, an individual associated with the VoIP client may specify which devices are to be used in connecting a call based on a variety of conditions (e.g., connection based on the calling party, the time of day, etc.). Moreover, the individual may identify which types of data items may be transmitted on a conversation channel given the device that is being used. For example, restrictions may be established so that, for example, memory intensive data items (e.g., images, video, etc.) are not directly transmitted to a client device that utilizes a limited bandwidth connection (e.g., wireless phone).

It is understood that the above mentioned configuration in the environment 100 is merely exemplary. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client.

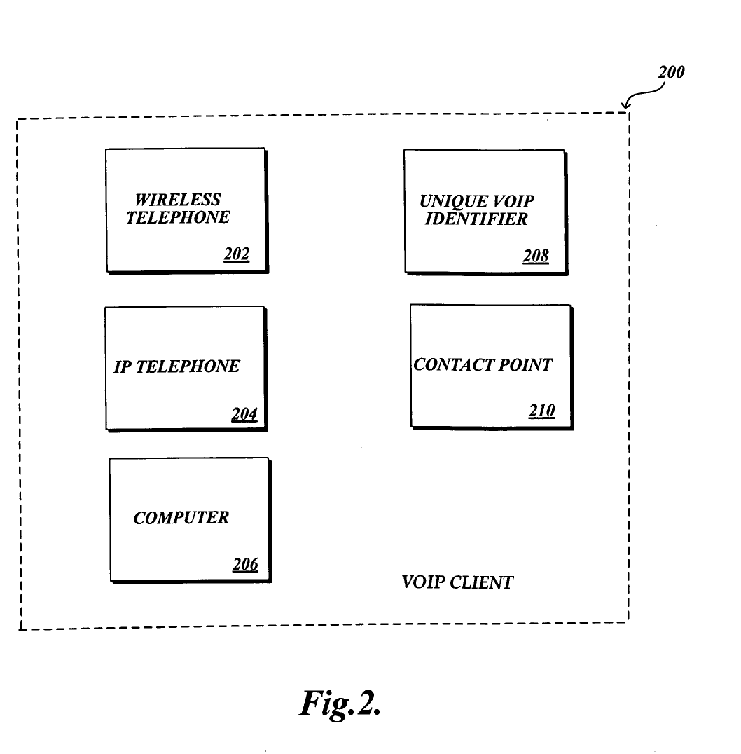

Referring now to FIG. 2, a block diagram illustrating an exemplary VoIP client 200 that includes several VoIP devices and a unique client identifier, in accordance with an embodiment of the present invention, is shown. Each VoIP device 202, 204, 206 may include a storage that is used to maintain voice messages, address books, client specified rules, restrictions and preferences on receiving data items concurrently with an incoming or out-going call, and/or rules for exposing functionality available from the client device, priority information related to incoming calls, etc. Alternatively, or in addition thereto, a separate storage, maintained for example by a service provider, may be associated with the VoIP client and accessible by each VoIP device that contains information relating to the VoIP client. In an embodiment, any suitable VoIP device such as a wireless phone 202, an IP phone 204, or a computer 206 with proper VoIP applications may be part of the VoIP client 200. The VoIP client 200 also maintains one or more unique client identifier 208. The unique client identifier(s) 208 may be constant or change over time. For example, the unique identifier(s) 208 may change with each call. The unique client identifier is used to identify the client and to connect with the contact point 210 associated with the VoIP client. The unique client identifier may be maintained on each VoIP device included in the VoIP client and/or maintained by a service provider that includes an association with each VoIP device included in the VoIP client. In the instance in which the unique client identifier is maintained by a service provider, the service provider may include information about each associated VoIP device and knowledge as to which device(s) to connect for incoming communications. In an alternative embodiment, the VoIP client 200 may maintain multiple client identifiers. In this embodiment, a unique client identifier may be temporarily assigned to the VoIP client 200 for each call session.

The unique client identifier may be used similar to a telephone number in PSTN. However, instead of dialing a typical telephone number to ring a specific PSTN device, such as a home phone, the unique client identifier is used to reach a contact point, such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

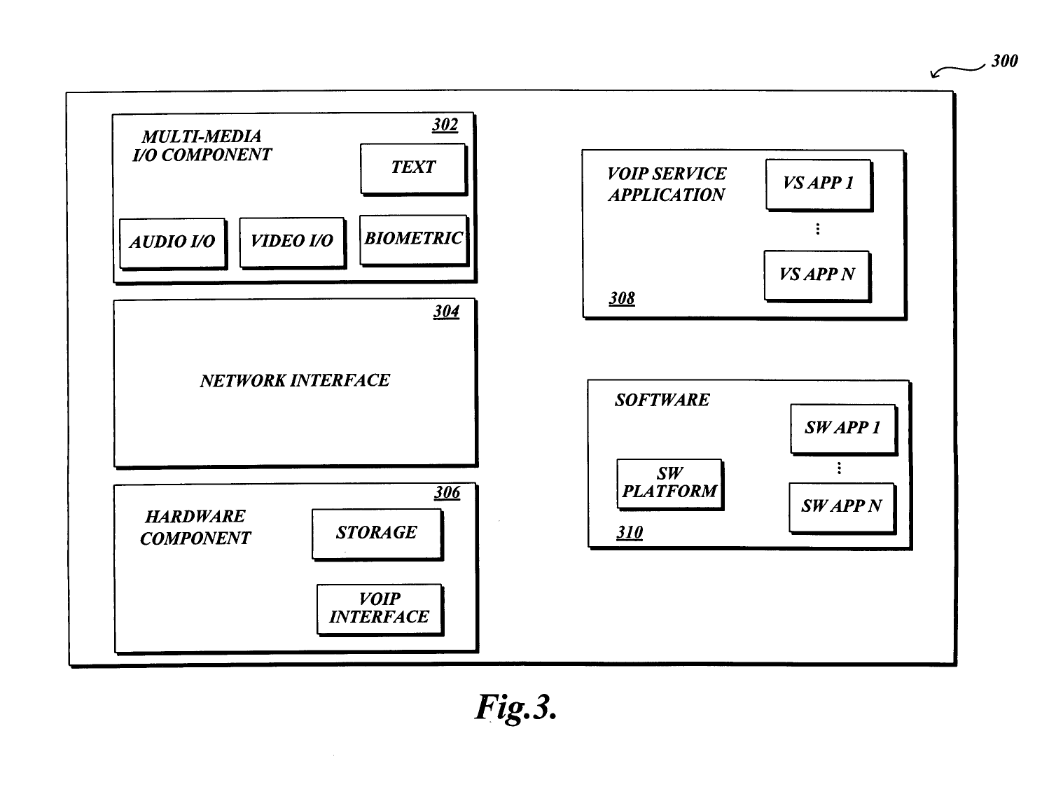

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting and processing various types of data packets. For example, the VoIP device 300 may include a multimedia input/output component 302 and a network interface component 304. The multimedia input/output component 302 may be configured to input and/or output multimedia data (including audio, video, and the like), user biometrics, text, application file data, etc. The multimedia input/output component 302 may include any suitable user input/output components such as a microphone, a video camera, a display screen, a keyboard, user biometric recognition devices, and the like. The multimedia input/output component 302 may also receive and transmit multimedia data via the network interface component 304. The network interface component 304 may support interfaces such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage such as read-only memory devices (ROM), random access memory (RAM), hard drives, optical drives, and the like. The storage may be configured to store program instructions for controlling the operation of an operating system and/or one or more applications and to store contextual information related to individuals (e.g., voice profiles) associated with the VoIP client in which the device is included. In one embodiment, the hardware component 306 may include a VoIP interface card, which allows non-VoIP client device to transmit and receive a VoIP conversation.

The device 300 may further include a software application component 310 for the operation of the device 300 and a VoIP Service application component 308 for supporting various VoIP services. The VoIP service application component 308 may include applications such as data packet assembler/disassembler applications, a structured hierarchy parsing application, audio Coder/Decoder (CODEC), video CODEC and other suitable applications for providing VoIP and other services. The CODEC may use voice profiles to filter and improve incoming audio.

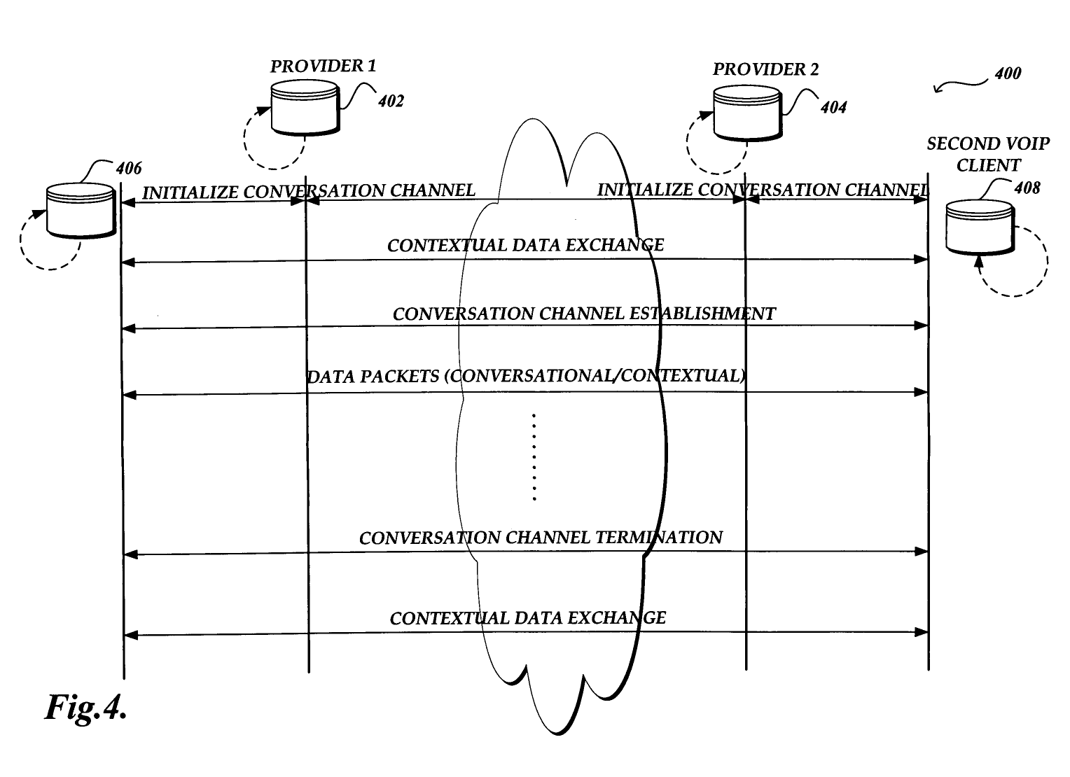

With reference to FIG. 4, a block diagram illustrative of a conversation flow 400 between VoIP devices of two different VoIP clients over a conversation channel, in accordance with an embodiment of the present invention, is shown. During a connection set-up phase, a VoIP device of a first VoIP client 406 requests to initiate a conversation channel with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 406. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer to peer context, communication between VoIP devices may also be direct without having any service providers involved.

There are a variety of protocols that may be selected for use in exchanging information between VoIP clients, VoIP devices, and/or VoIP service providers or other VoIP entities. For example, when Session Initiation Protocol (SIP) is selected for a signaling protocol, session control information and messages will be exchanged over a SIP signaling path/channel and media streams will be exchanged over Real-Time Transport Protocol (RTP) path/channel. For the purpose of discussion, a communication channel, as used herein, generally refers to any type of data or signal exchange path/channel. Thus, it will be appreciated that depending on the protocol, a connection set-up phase and a connection termination phase may require additional steps in the conversation flow 400.

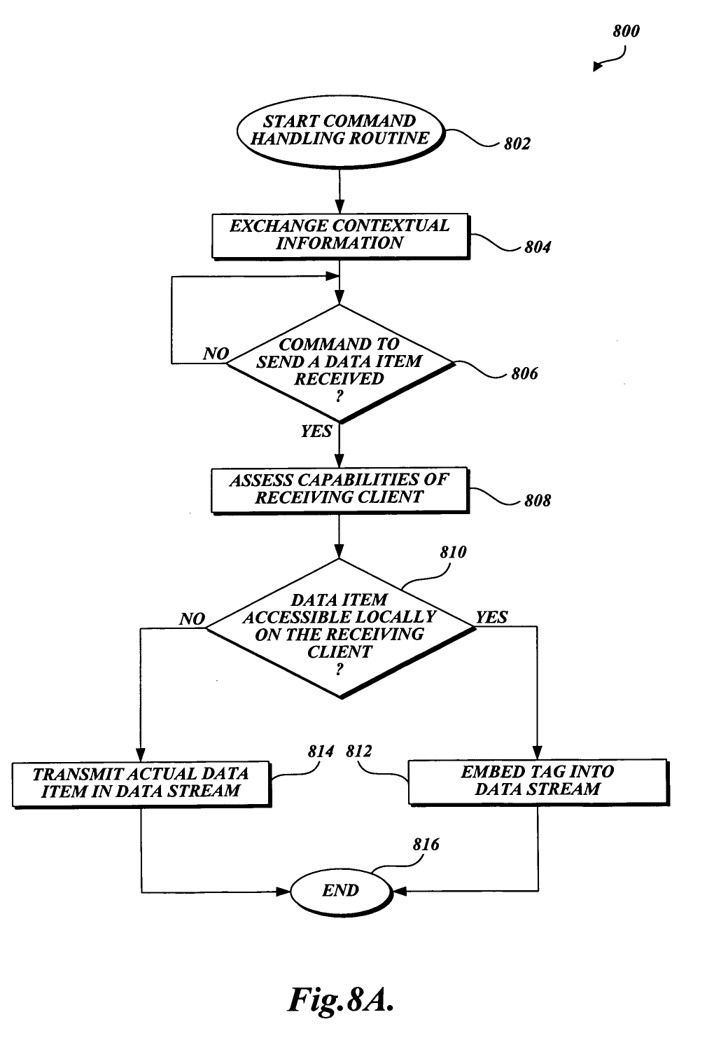

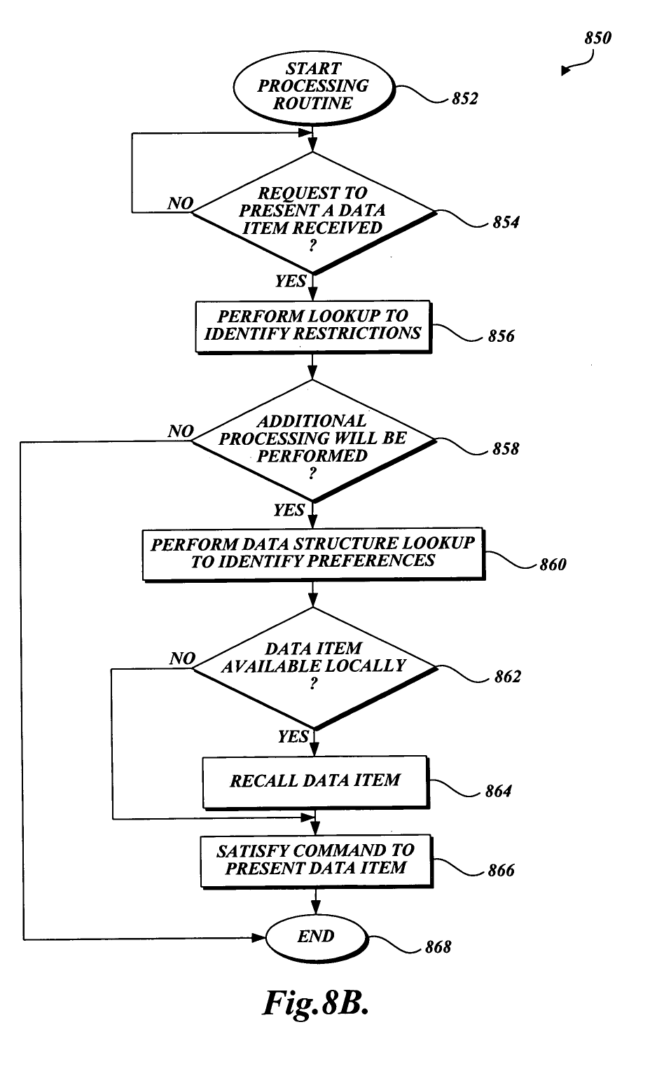

For ease of explanation, we will utilize the example in which both the first VoIP client 406 and the second VoIP client 408 each only includes one VoIP device. Accordingly, the discussion provided herein will refer to connection of the two VoIP devices. The individual using the device of the first VoIP client 406 may select or enter the unique client identifier of the client that is to be called. Provider 1 402 receives the request from the device of the first VoIP client 408 and determines a terminating service provider (e.g., Provider 2 404 of the second VoIP client 408) based on the unique client identifier included in the request. The request is then forwarded to Provider 2 404. This call initiation will be forwarded to the device of the second VoIP client. A conversation channel between the device of the first VoIP client 406 and a device of the second VoIP client 408 can then be established. As described in further detail below, with reference to FIG. 8A, data items may be immediately transmitted when the communication channel is established. As a result, an individual may receive a data item when a call is received. Moreover, client devices may be used to exchange data items at any point after a communication channel is established and before the communication channel is terminated.

In an illustrative embodiment, before the devices of the first VoIP client 406 and the second VoIP client 408 begin to exchange data packets, contextual information may be exchanged. As will be discussed in a greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, and the VoIP client 408 being called. For example, the contextual information sent from the called VoIP client 406 may include priority list of incoming calls from various potential calling VoIP clients including VoIP client 406, rules and preferences for exchanging data items and accessing functionality available from the VoIP clients, and the like.

Available media types, rules of the calling client and the client being called, and various data items may also be part of the contextual information that is exchanged during the connection set-up phase. The contextual information may be processed and collected by one of the devices of the first VoIP client 406, one of the devices of the second VoIP client 408, and/or by VoIP service providers (e.g., Provider 1 402 and Provider 2 404), depending on the nature of the contextual information. In one embodiment, the VoIP service providers 402, 404 may add/or delete some information to/from the client's contextual information before forwarding the contextual information, perform filtering on incoming or outgoing contextual information, and the like.

In response to a request to initiate a conversation channel, the second VoIP client 408 may accept the request for establishing a conversation channel or execute other appropriate actions such as rejecting the request or causing contextual information such as a data item to be “buffered” by the Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail, the data packets, including conversation data packets and contextual data packets, are communicated over the established conversation channel between the connected devices.

Conversation data packets carry data related to a conversation, for example, a voice data packet, or multimedia data packet. Contextual data packets carry information relating to data other than the conversation data. Once the conversation channel is established, either the first VoIP client 406 or the second VoIP client 408 can request to terminate the conversation channel. Moreover, either of the clients 406 or 408 may generate commands to transmit additional contextual information during a call such as data items that are irrelevant to the conversation. Some contextual information may be exchanged between the first VoIP client 406 and the second VoIP client 408 after the termination.

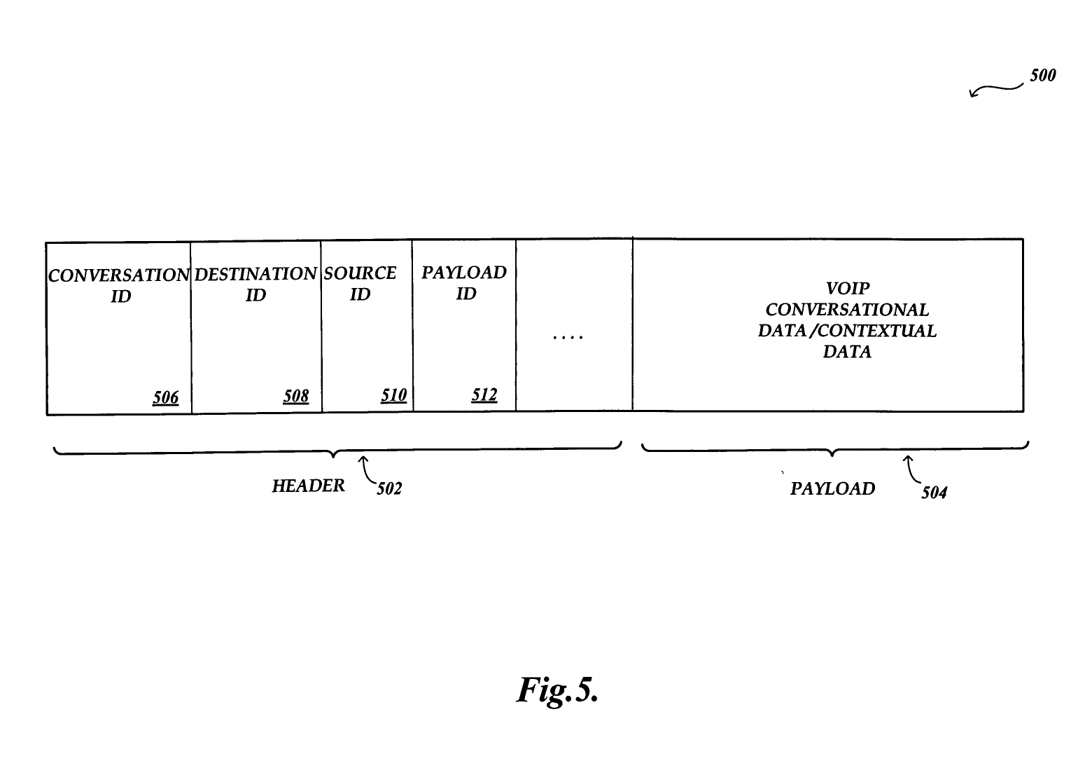

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services, and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. Such information may include conversation ID 506 for identifying a conversation (e.g., call), a Destination ID 508, such as a unique client identifier of the client being called, a Source ID 510 (unique client identifier of the calling client or device identifier), Payload ID 512 for identifying type of payload (e.g., conversation or contextual), individual ID (not shown) for identifying the individual for which the conversation data is related, and the like. In an alternative embodiment, the header 502 may contain information regarding Internet protocol versions, and payload length, among others. The payload 504 may include conversational or contextual data relating to an identified conversation. As will be appreciated by one of ordinary skill in the art, additional headers may be used for upper layer headers such as a TCP header, a UDP header, and the like.

In one embodiment of the present invention, a structured hierarchy may be predefined for communicating contextual information over a VoIP conversation channel. The contextual information may include any information relating to VoIP clients, VCD devices, conversation channel connections (e.g., call basics), conversation context (e.g., call context), and the like. More specifically, the contextual information may include client preference, client rules including rules for accessing functionality available from the VoIP clients, restrictions on sending and receiving data items, client's location (e.g., user location, device location, etc.), biometrics information, the client's confidential information, VoIP device's functionality, VoIP service providers information, media type, media parameters, calling number priority, keywords, information relating to application files, and the like. The contextual information may be processed and collected at each VoIP client and/or the VoIP service providers depending on the nature of the contextual data. In one aspect, the VoIP service providers may add, modify, and/or delete VoIP client's contextual data before forwarding the contextual information. For example, client's confidential information will be deleted by the VoIP service provider associated with that client unless the client authorizes such information to be transmitted. In some cases, a minimal amount of contextual information or no contextual information may be exchanged.

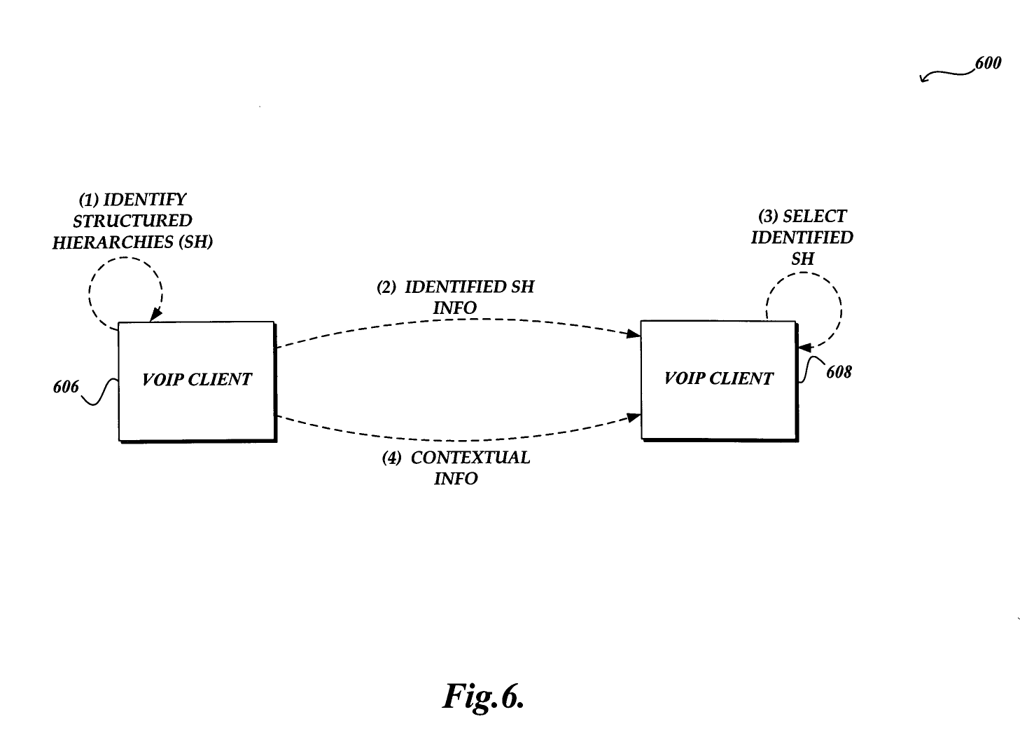

With reference to FIG. 6, a block diagram 600 illustrating interactions between two VoIP clients for transferring contextual information, in accordance with an embodiment of the present invention, is shown. As with FIG. 4, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchy, and the like. Such information will be exchanged between VoIP Client 606 and VoIP Client 608 before the corresponding contextual information is exchanged. Upon receipt of the information about which structured hierarchy is used to carry the contextual information, VoIP Client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated and thus the amount of transmitted data packets corresponding to the contextual data is reduced. Further, by employing the predefined structured hierarchies, data packets can be transmitted in a manner, which is independent of hardware and/or software.

Upon retrieving the identified structured hierarchy, VoIP Client 608 is expecting to receive a data stream such that data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

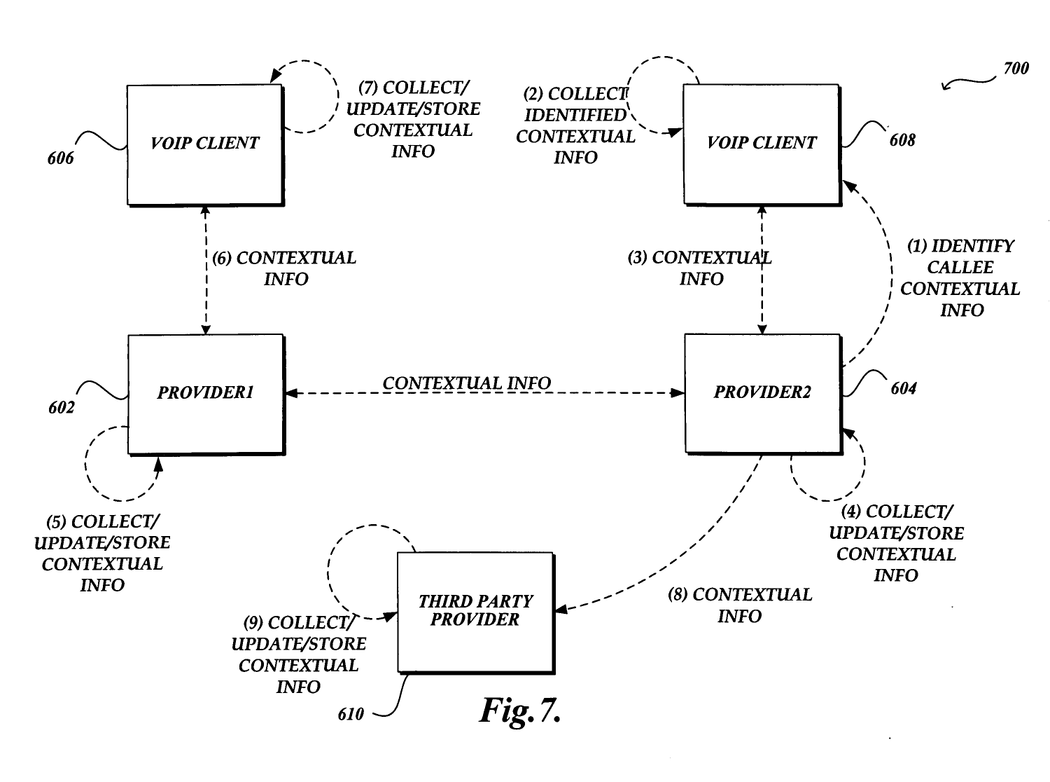

With reference to FIG. 7, a block diagram 700 illustrating interactions among several VoIP entities for collecting and transferring contextual information via various service providers, in accordance with an aspect of the present invention. In one embodiment, the contextual information may be exchanged between a sending party and a receiving party. The sending party described herein may be any VoIP entity (e.g., a client, a device, a service provider, a third party service provider, etc.) which can collect and transmit a set of contextual information which is represented based on corresponding structured hierarchies. Likewise, the receiving party described herein may be any VoIP entity which can request a set of contextual information from the sending party. In this embodiment, a VoIP entity can be either a sending party or receiving party in any given exchange of contextual information.

In an illustrative embodiment, a third party service provider 610 may receive contextual information of VoIP Clients 606, 608 from VoIP service providers 602, 604. For discussion purposes, assume that each client only has one device associated therewith and the connection occurs between those two devices. Additionally, VoIP Client 606 has Provider 1 602 for the VoIP service provider and a third party provider 610 is available for additional VoIP services. While this example utilizes two VoIP service providers and two VoIP clients, any number and combination of VoIP clients and/or service providers may be used with embodiments of the present invention. In one embodiment, devices of VoIP Client 606 and VoIP Client 608 have established a conversation channel via Provider 1 602 and Provider 2 604.

During a VoIP conversation, Provider 2 604 may identify contextual information which will be obtained from VoIP Client 608. VoIP Client 608 collects the identified contextual information and identifies structured hierarchies which will be used to carry the identified contextual information. The collected contextual information is transmitted from VoIP Client 608 to Provider 2 604. Provider 2 604 is the receiving party and VoIP Client 608 is the sending party in this transmission of the contextual information. Provider 2 604 may store all or part of the received contextual information, filter the contextual information, and the like. Further, Provider 2 604 may collect more information, if necessary, and update the received contextual information based on the information. In one embodiment, Provider 2 604 may add service provider information relating to services provided for VoIP Client 608, such as billing information, rates, and the like. Similarly, Provider 2 604 may delete and/or modify contextual data from the received contextual information.

In an illustrative embodiment, the information regarding the identified structured hierarchies is also transmitted to Provider 2 604. The information regarding the identified structured hierarchies may include the information about which structured hierarchies are used to carry the contextual information, how to identify the structured hierarchies, and the like. Provider 2 604 transmits the information regarding the identified structured hierarchies and the contextual information to Provider 1 602. In this example, Provider 2 604 is now the sending party and Provider 1 602 is the receiving party of the contextual information. Provider 1 602 may collect more contextual information, if necessary, and update the received contextual information. Moreover, Provider 1 602 may add, delete, and/or modify a contextual data before forwarding the received contextual information to VoIP Client 606. Provider 1 602 transmits the contextual information to VoIP Client 606. Likewise, VoIP Client 606 may further collect contextual information and transmit the collected contextual information and corresponding structured hierarchies information to VoIP Client 608 via Provider 1 602 and Provider 2 604.

As will be discussed in greater detail below, it is to be understood that a VoIP entity can be both a sending party and a receiving party at the approximate same time. For example, Provider 1 602 may also receive a first set of contextual information from VoIP Client 606 while receiving a second set of contextual information relating to VoIP Client 608 from Provider 2 604. Upon receipt of the contextual information, Provider 1 602 transmits the first set of contextual information to Provider 2 604 while receiving the second set of contextual information from Provider 2 604. Likewise, VoIP Clients 606,608 can receive contextual information from their service providers while transmitting contextual information to their service providers. As such, it is contemplated that contextual information will be continuously exchanged among VoIP entities (e.g., Provider 1 602, VoIP Client 606, Provider 2 604, VoIP Client 608) before, during, and after a conversation over a two-way communication channel.

In one embodiment, Provider 1 602 sends the information regarding the identified structured hierarchies and the contextual information to VoIP Client 606. As mentioned above, VoIP Client 606 further processes the received contextual information in accordance with the identified structured hierarchies. For example, upon receipt of the information regarding the identified structured hierarchies, VoIP Client 606 looks up predefined structured hierarchies to select the identified structured hierarchies for the contextual information.

In one embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known for a cross-platform, software, and hardware independent tool for transmitting information. Further, XML maintains its data as a hierarchically-structured tree of nodes, each node comprising a tag that may contain descriptive attributes. XML is also well known for its ability to follow extendable patterns that may be dictated by the underlying data being described. Typically, a XML namespace is provided to give the namespace a unique name. In some instances, the namespace may be used as a pointer to a centralized location containing default information about the namespace.

In a particular embodiment, VoIP Client 606 may identify a XML namespace for contextual information. For example, the XML namespace attribute may be placed in the start tag of a sending element. It is to be understood that XML namespaces, attributes, and classes illustrated herein are provided merely as an example of structured hierarchies used in conjunction with various embodiments of the present invention. After VoIP Client 608 receives the XML namespace information, the VoIP Client 606 transmits a set of contextual data packets defined in accordance with the identified XML namespace to VoIP Client 608. When a namespace is defined in the start tag of an element, all child elements with the same prefix are associated with the same namespace. As such, VoIP Client 608 and VoIP Client 606 can transmit contextual information without including prefixes in all the child elements, thereby reducing the amount of data packets transmitted for the contextual information.

With reference now to FIGS. 8A-8B, aspects of the present invention will be described that are directed at allowing a sending party to transmit a data item as contextual information to a receiving party. In this regard and in accordance with one embodiment, controls for generating a command to transmit a data item concurrently with conversational data are provided. For example, if the subject matter of a conference call relates to an electronic document, such as a word processing document, a control may be activated for the purpose of transmitting the document, or an updated version of the document, to one or more receiving parties involved in the conference call. Contextual information that identifies the document may be identified in structured hierarchies thereby allowing the document to be processed and presented to the receiving parties. While specific examples of data items that may be transmitted concurrently with a call conversation are described below, those skilled in the art and others will recognize that other types of data items may be transmitted and the examples provided below should be construed as exemplary and not limiting.

Now with reference to FIG. 8A, an exemplary command handling routine 800 will be described. Generally described, the command handling routine 800 implements logic that allows a sending client to transmit a selected data item to a receiving client. As an initial matter, the command handling routine 800 may be implemented in an application program that provides functionality for sending and receiving calls in a VOIP environment or otherwise facilitating the exchange of conversational data. For example, prior to the command handling routine 800 being executed, a caller may use the application program and/or VoIP devices to cause a communication channel to be established with one or more receiving parties.

By way of example only, a caller may identify parties that will be included in the call conversation from an electronic “address book” provided by the application program. Then, once the parties to the call conversation have been identified, hardware or software based controls may be used to initiate the call. In this regard, a VoIP client may use various devices to send or receive data over a communication channel. The application program may be configured to manage communication between and provide enhanced functionality for the devices. In this regard, a sending party may use a feature-rich VoIP client that consists of a personal computer communicatively connected to a VoIP enabled telephone, for example. The sending party may identify parties that will be included in the call conversation and initiate the call by activating one or more software controls (e.g., button, menu item, etc.) made available from the application program. Once a communication channel has been established, conversational data may be input and received using the VoIP telephone. Alternatively, hardware controls available from the VoIP telephone (e.g., dial pad) may be used to initiate the call. As this example illustrates, aspects of the present invention may be applied in VoIP clients with any number of different device configurations and capabilities.

In one embodiment, controls available from an application program allow the sending party to identify and send a data item when the call is initiated. For example, an application program may provide functionality for browsing a file system or network location so that a sending party may identify a data item that will be sent to a receiving party when a call is initiated. Moreover, as described in further detail below, packaged data items may also be selected inside an application program. In any event, any number of different types of data items may be identified and transmitted as a call is initiated. As described in further detail below, a data item transmitted concurrently with a call may be in any number of different formats including audio, text, image, and/or procedural, etc. Moreover, when a data item is received processing may be performed on the contextual information so that the data item may be made available to the receiving party. For example, if a sending party causes a word processing document to be sent when a call is initiated, an application program available from the receiving client may be configured to process the received contextual information and automatically present the word processing document as the call is received.

As illustrated in FIG. 8A, the command handling routine 800 begins at block 802, and at block 804 sets of contextual information are exchanged between clients being used in a call conversation. In one embodiment and as described previously, contextual information may be exchanged as structured hierarchies that are defined in accordance with an XML namespace. Moreover, not only is contextual information exchanged in this way during an initial set-up phase (at block 802), the contextual information may be also exchanged after the initial set-up phase during a call conversation, or after call termination. Although the illustrative embodiment described in connection with the command handling routine 800 is focused on interactions that occur between two clients, the routine 800 is equally applicable when more than two clients or other VoIP entities are participating in a call (e.g., conference call).

It should be well understood that a communication channel between sending and receiving parties may be established across any number of different VoIP entities (e.g., clients, client devices, service providers, third party service providers, etc.). Stated differently, the contextual information exchanged between the clients associated with a sending and receiving party, at block 804, may be received by one or more intervening VoIP entities that forward the contextual information. Thus, the contextual information exchanged at block 804 may be forwarded multiple times before being received at the appropriate client.

At block 806, the command handling routine 800 remains idle until a command to transmit a data item from a sending party to a receiving party is received. As mentioned previously, aspects of the present invention allow a sending party to select and send a data item when a call is initiated. Similarly, a sending party may also select and cause a data item to be transmitted to a receiving party while a call conversation is on-going. For example, a party to a conference call may receive an electronic document when a call is initiated, update the document during the call, and subsequently send the updated version of the document to one or more receiving parties. Those skilled in the art and others will recognize that when a command to transmit a data item is received, event data may be obtained. As described in further detail below, the event data obtained by the command handling routine 800 may identify, among other things, the data item that is the object of the command, the identity of the receiving parties, and the like. In one embodiment, the command is generated at block 806 when a sending party interacts with a user interface to issue the command. In another embodiment, a sending party may cause the command to be automatically based on rules which are me depend on variables. For example, a sending party may establish a rule to automatically send a selected data item when a call from a particular individual is received. More generally, those skilled in the art and others are will recognize that any number of different types of rules may be established for automatically sending a data item.

Typically, a data item transmitted to a receiving party concurrently with conversation data originates from a party to the call. However, a data item may also originate from any intervening VoIP entity such as a third party service provider that receives and forwards call data. In this regard, an intervening VoIP entity may be configured to add/remove contextual information to a call conversation based on pre-defined rules. For example, an intervening VoIP entity may cause additional contextual information to be transmitted over an existing communication channel in order to cause a “broadcast message” with emergency information to be made available to parties involved in a call. Moreover, those skilled in the art and others will recognize that other instances exist where it may be desirable for an intervening VoIP entity to add/remove other types of contextual information.

Any number of different controls, including both hardware and software based controls, may be used to generate the command that is received at block 806. For example, a device such as a VoIP telephone may be configured with hardware controls that enable a sending party to cause a data item to be transmitted to a receiving party. By way of another example, an application program may provide software-based controls that enable a sending party to select and send a data item. In this instance, features may be provided that allow the sending party to differentiate between parties who will receive the data item. For example, in accordance with one embodiment, software controls are provided that allow a sending party to send a data item to a selected receiving party without the data item being received by a non-selected party.

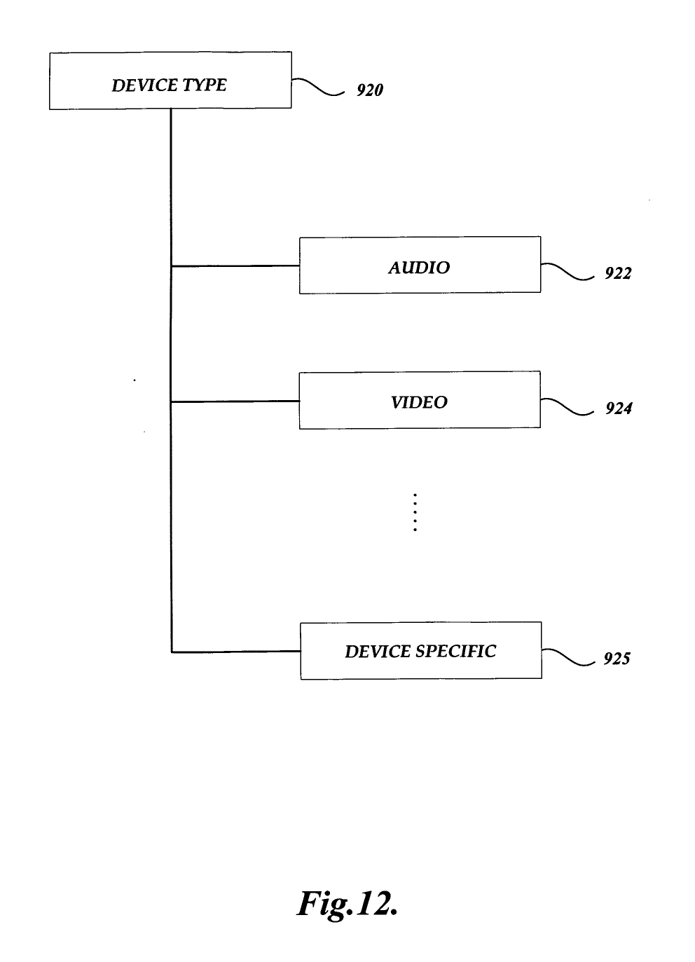

Upon the command being received, the command handling routine 800 processes the contextual information received during the call set-up phase to assess the capabilities, preferences, and rules of the receiving client, at block 808. As mentioned previously, a party to a call may employ any number of different types of clients, with each client having potentially different device configurations and capabilities. For example, some feature-rich clients are able to present or process date items that adhere to any number of different formats including, but not limited to, audio, text, image, and/or procedures. Other clients are more limited and, for example, may only be able to send/receive audio data. Since the capabilities, preferences, and rules associated with the client being used by the receiving party may affect how and whether the data item will be presented, the capabilities, preferences, and rules associated with the client are identified. In accordance with one embodiment, the capabilities, preferences, and rules associated with the client are identified from contextual information represented in the Device Type Class 920, described in further detail below with reference to FIG. 12.

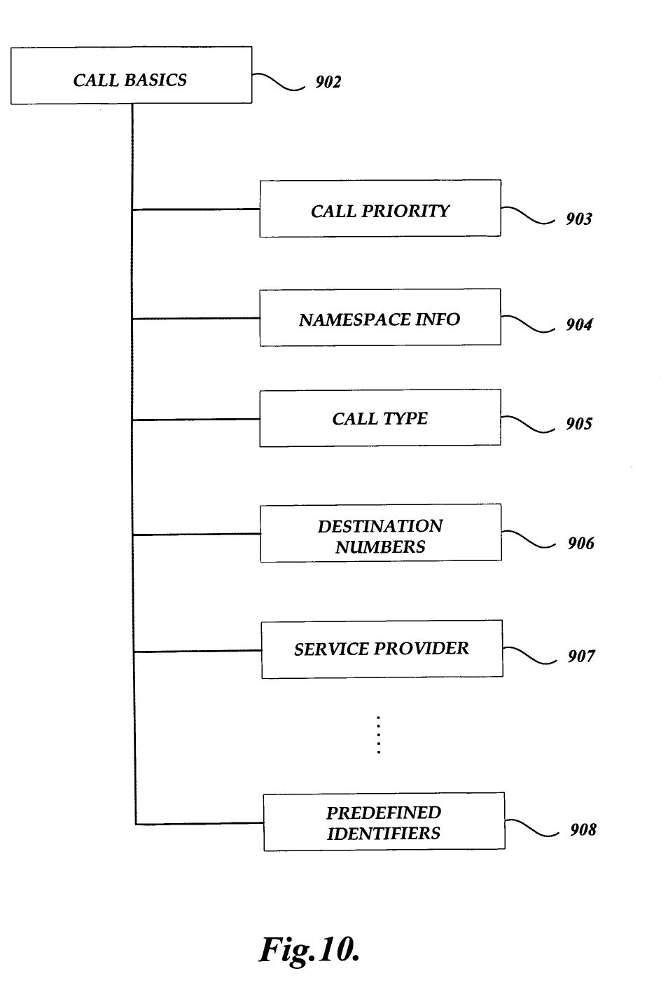

In one embodiment, packaged data items of graphical representations and/or animations may be transmitted during a call. For example, using controls provided by the present invention, a sending party may select a graphical representation and/or animations from a package of data items that includes, but is not limited to, smiles, frowns, winks, or other facial expression that depict a human emotion. In this regard, the contextual information exchanged in the call set-up phase (at block 804) may identify the packages of data items available from the sending and receiving client. In one embodiment, the processing performed at block 808 includes identifying the packages of data items that are locally available on the receiving client. If a specified data item is locally available on the receiving client, the actual data item is not transmitted in response to receiving the appropriate command. Instead, a reference to the data item is transmitted which enables the receiving client to recall and present the data item. In one embodiment, graphical representations and/or animations of human emotions relating to a conversation context are represented by the Call Basics Class 904, described in further detail below with reference to FIG. 10.

In another embodiment, packaged data items for accessing functionality exposed by a receiving client may be transmitted during a call. Using controls provided by the present invention, a sending party may generate a remote procedure call to cause a specified action to occur on a receiving client. For example, a device associated with the receiving client, such as wireless phone, may maintain functionality to vibrate, signify that a call is incoming by playing an identified audio file, display an image, etc. Those skilled in the art and others will recognize that, functionality provided by a device may be exposed from a programming interface. In one embodiment, remote procedure calls that cause a device associated with receiving client such as a wireless phone to vibrate, play a received audio file, display an image, etc. may be issued from a sending client. The functionality may be accessed at any point when a communication channel is established including when is initiated or while conversation data is being exchanged. In this regard, the contextual information exchanged in the call set-up phase (at block 804) may identify the functionality exposed by a receiving client.

At block 810, a determination is made regarding whether the data item that is the object of the command, received at block 806, may be accessed locally from the receiving client. In some instances, a data item is either not locally available on the receiving client or may only be accessed from the sending client. For example, in one embodiment, a sending party may issue a command to multiplex an audio file in a call for the purpose of providing “background music.” The sending party identifies an audio file and selects a control to transmit the audio file and call data in the form of the single multiplexed data stream. In this and other instances when a data item is only available from a sending client, the result of the test performed at block 810 is “NO” and the command handling routine 880 proceeds to block 814, described below. Conversely, a data item may be locally available on a receiving client. For example, graphical representations and/or animations that depict human emotions or other packaged data items and related procedures may be distributed to a plurality of clients. In this instance, if a package that includes the selected data item was distributed to the receiving client, then a determination is made that the data item is available locally. In this and other instances, when the selected data item is available locally on the receiving client, the result of the test performed at block 810 is “YES” and the command handling routine 800 proceeds to block 812.

At block 812, a tag describing a data item that will be made available to a receiving party is embedded in the data stream being transmitted to the receiving client. If block 812 is reached, a determination was made that the data item selected by a sending party may be accessed locally from the receiving client. In this instance, the selected data item will not be transmitted. Instead, a “tag” or segment of text that describes the selected data item and related procedures is transmitted as contextual information between the sending and receiving clients. Those skilled in the art and others will recognize that a tag which conforms to XML or other standardized format may be used to describe the semantics of identifying and presenting the data item on the receiving client. For example, the tag embedded in the data stream at block 812 may include the addresses of the destination and sending clients, processing instructions, the identity of the selected data item, and the like. As described in further detail below, when a tag embedded in a data stream is received, the certain instructions may be executed for the purpose of presenting the data item to the receiving party. Then, the command handling routine 800 proceeds to block 816, where it terminates.

At block 814, the command handling routine 800 causes the actual data item to be included in a data stream being transmitted to the receiving client. Stated differently, data packets with the appropriate header information and data item represented in the payload are transmitted to the receiving client if block 814 is reached. In one embodiment, contextual information in the form of electronic documents (e.g., word processing documents, spreadsheets, PowerPoint presentations, and the like), graphical representations and/or animations (pictures, images, icons, etc.), procedure calls, and/or any other data type that may be represented digitally, etc., may be transmitted in the data stream. In another embodiment, the contextual information is continually embedded or multiplexed with the data stream that is being transmitted. For example, as mentioned previously, a sending party may issue a command to multiplex an audio file in a call for the purpose of providing “background music.” In this instance, an audio file identified by the sending party is continually multiplexed with conversational data that is transmitted to a receiving client. Then, the command handling routine 800 proceeds to block 816, where it terminates.

Now with reference to FIG. 8B, an exemplary processing routine 850 that implements logic for making a data item available on a receiving client will be described. Similar to the description provided above with referenced FIG. 8A, the processing routine 850 may be implemented in an application program that provides functionality for sending and receiving calls in a VoIP environment. In this regard, prior to the processing routine 850 being executed, a sending or receiving party may use the application program to establish a communication channel. However, unlike the description provided above with referenced FIG. 8A, the processing routine 850 implements instructions for making a data item available to a receiving party.

As illustrated in FIG. 8B, the processing routine 850 begins at block 852 and at block 854 it remains idle until a request to present a data item is received from a sending client. As described previously with reference to FIG. 8A, aspects of the present invention provide controls for generating a command received automatically or based on input from a user interface to present or otherwise make a data item available to a receiving party. The command handling routine 800 may embed a reference or an actual data item in a data stream that is transmitted to the receiving client. As the data stream is received, contextual information in the data stream is parsed to determine whether a request to present the data item was received. For example, instructions for presenting the data item may be embedded in the data stream in an XML tag. When this type of information is received, the command handling routine 800 determines that instructions to present a data item were received and proceeds to block 856.

At block 856, a data lookup is performed to identify any restrictions that may exist in presenting the data item on the receiving client. As mentioned previously, any number of different clients may be used in a call, with each client having different capabilities. In some instances, a receiving client may not be able to present the type of data item that was transmitted by a sending client. For example, a sending party may issue a command to transmit an electronic document or an image to a receiving party. If the receiving party is using a limited-feature client device such as a POTS telephone, the data items are not capable of being presented. In this instance, when a receiving client is not capable of presenting a data item, the processing routine 850 may identify a file name for the data item and notify the receiving party that the data item was sent. Moreover, an intervening VoIP entity may make the stored data item available to a receiving party sometime later in a voicemail message or other electronic communication.

A data item that is not capable of being presented on a receiving client may be “buffered” and subsequently made available to a receiving party. In this regard, it is also contemplated that the request to present a data item may not be processed at all but stored for future use on a device, local storage of a service provider, or the like. In this regard, a sending party may establish a rule to have a data item transmitted to the receiving party at the occurrence of a specified event. Stated differently, the rules for sending a data item may be based on any number of different variables. For example, a sending party may establish a rule to cause a specified data item to be transmitted after a specified period of time or regularly schedule intervals, when the receiving party is identified as being “online,” using a feature-rich client capable of presenting a data item, etc.

Restrictions may be placed on presenting a data item to a receiving party based on policies. For example, anti-malware software may be configured to search network traffic being sent to a receiving client. If a data item sent to the receiving client is characteristic of malware (e.g., viruses, worms, spyware, Trojans, etc.) a restriction may be placed on presenting or otherwise executing instructions associated with the data item. Similarly, the receiving party may define restrictions on presenting certain types of data items that depend on variables. By way of example only, if the receiving party is using a wireless telephone that maintains a limited bandwidth connection, restrictions may be defined so that a memory intensive data item (e.g., image, video, etc.) may not be transmitted to the wireless telephone. Instead, the data item may be buffered by an intervening VoIP entity and accessed at a later time when, for example, the receiving party is using a client that maintains a higher bandwidth connection. By way of another example, a user with elevated privileges (e.g., parents) may place restrictions on the types of data items that other users (e.g., children) may receive from a sending party.

Restrictions may be placed on presenting a data item based on rules established by a receiving party. For example, as mentioned previously, a sending party may issue a command to cause an audio file to be sent and played on a receiving client. However, a receiving party may establish a rule to allow audio files to be played based on variables such as only allowing an audio file to be played during pre-defined periods of time. These examples illustrate that aspects of the present invention are highly configurable and other types of restrictions, and/or rules may be defined without departing from the scope of the claimed subject matter.

At decision block 858, the processing routine 850 determines whether additional processing will be performed based on the restrictions, if any, identified at block 856. As mentioned previously, restrictions may be established when malware is identified, a policy or rule is defined, etc. In these instances when a data item is not allowed to be presented, a determination is made that the result of the test performed at block 858 is “NO,” and the processing routine 850 proceeds to block 868, where it terminates. In instances when a restriction that prevents instructions associated with a data item from being executed does not exist, the processing routine 850 proceeds to block 860.

At block 860, a data structure lookup is performed to identify preferences on how a data item will be made available to a receiving party. In one embodiment, preferences may be established by a receiving party or default that define how different types of data items are presented or otherwise made available. In this regard, if the data item received adheres to a specified file type (e.g., ”.doc”), preferences may be defined that cause a particular application program (e.g., Microsoft Word®) to be launched so the data item may be immediately accessed by a receiving party. Moreover, preferences that depend on variables may affect which data items are presented to a receiving party. In this regard, a receiving party may establish a rule to associate and play an audio file when a particular individual initiates a call. Regardless of the data item received from sending party in this instance, the preference established by the receiving party may override which audio file is played as the call is initiated. However, those skilled in the art will recognize that other preferences may be defined which depend on any number of different types of variables.

As illustrated in FIG. 8B, at block 862, a determination is made regarding whether a specified data item is available locally on the receiving client. If block 862 is reached, a restriction designed to prevent a data item from being presented to a receiving party was not identified. In this instance, the processing routine 850 allows instructions for handling the request received at block 854 to be executed. However, as described previously, a data item may be accessed locally from the receiving client or the actual data item may be embedded in a data stream. In an alternative embodiment, a data item may be available from a network accessible data store. In any event, an XML tag may be received when a data item is available locally on the receiving client. This may occur, for example, if the data item is included in a package of data items that is available on both the sending and receiving clients. In this instance, a determination is made that the data item is available locally, and the processing routine 850 proceeds to block 864. Alternatively, if the actual data item is included in the data stream, then a determination is made that the data item is not available locally and the processing routine proceeds to block 866.

At block 864, the data item identified in the request received at block 854 is recalled from storage available to the receiving client. As mentioned previously, a tag that describes a data item and related functionality may be transmitted as contextual information between the sending and receiving clients. In this regard, the tag may describe the semantics associated with the data item, including the identity of the data item and/or package where the data item may be located, instructions for presenting the data item to the receiving party, and the like. At block 864, text included in the tag received from the sending client is parsed to identify where the data item is stored. Then, the data item is recalled so that it may be presented or otherwise made available.

At block 866, the command generated by the sending party is satisfied when a data item is presented or otherwise made available on the receiving client. Presenting the data item may include applying preferences established by a receiving party or provided by default. For example, as mentioned previously, presenting the data item may include identifying an appropriate application program, launching the application program, and using the application program to display the data item. Similarly, if the receiving party is currently interacting with an appropriate application program, presenting the data item may include “refreshing” a graphical user interface, thereby causing the data item to be displayed. Moreover, presenting the data item may include issuing a procedure call to a program interface that is accessible from the receiving client. For example, functions may be issued to cause a client device to vibrate, play an identified audio file, display an image, etc. Then, the processing routine 850 proceeds to block 868, where it terminates.

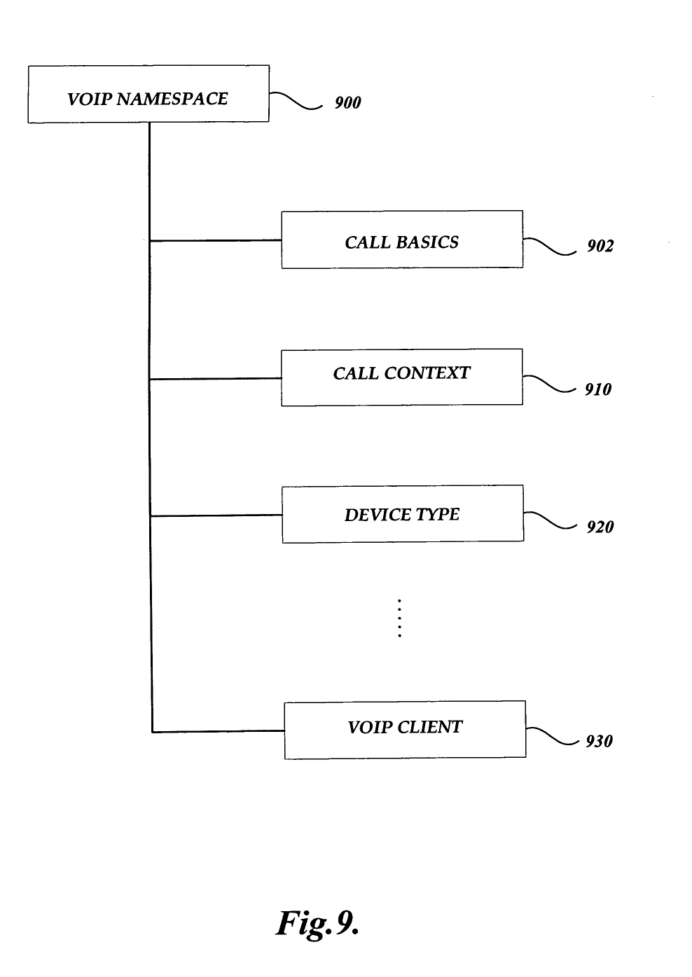

With reference to FIGS. 9-12, block diagrams illustrative of various classes and attributes of structured hierarchies corresponding to VoIP contextual information are shown. As mentioned above, structured hierarchies are predefined organizational structures for arranging contextual information to be exchanged between two or more VoIP devices. Structured hierarchies can be defined, updated, and/or modified by redefining various classes and attributes. The VoIP contextual information exchanged between various VoIP entities may correspond to a VoIP namespace 900. In one embodiment, the VoIP namespace 900 is represented as a hierarchically structured tree of nodes, each node corresponding to a subclass which corresponds to a subset of VoIP contextual information. For example, a VoIP Namespace 900 may be defined as a hierarchically structured tree comprising a Call Basics Class 902, a Call Contexts Class 910, a Device Type Class 920, a VoIP Client Class 930, and the like.

With reference to FIG. 10, a block diagram of a Call Basics Class 902 is shown. In an illustrative embodiment, Call Basics Class 902 may correspond to a subset of VoIP contextual information relating to a conversation channel connection (e.g., a PSTN call connection, a VoIP call connection, and the like). The subset of the VoIP contextual information relating to a conversation channel connection may include originating numbers (e.g., a caller's client ID number), destination numbers (e.g., callees' client ID numbers or telephone numbers), call connection time, VoIP service provider related information, and/or ISP related information such as IP address, MAC address, namespace information, and the like. Additionally, the contextual information relating to a conversation channel connection may include call priority information (which defines the priority levels of the destination numbers), call type information, rules for sending/receiving data items, and the like. The call type information may indicate whether the conversation channel is established for an emergency communication, a broadcasting communication, a computer to computer communication, a computer to POTS device communication, and so forth. In one embodiment, the contextual information relating to a conversation channel connection may include predefined identifiers which represent emotions, sounds (e.g., “ah,” “oops,” “wow,” etc.), and graphical representations and/or animations of facial expressions. In one embodiment, a Call Basics Class 902 may be defined as a sub-tree structure of a VoIP Namespace 900, which includes nodes such as call priority 903, namespace information 904, call type 905, destination numbers 906, service provider 907, predefined identifiers 908, and the like.

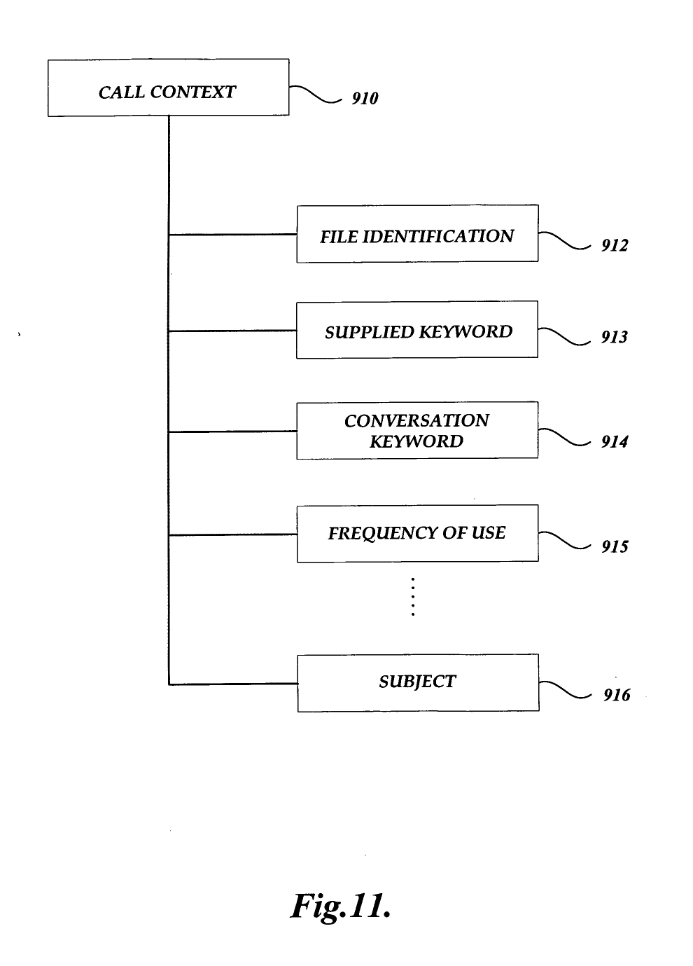

With reference to FIG. 11, a block diagram of a Call Contexts Class 910 is shown. In one embodiment, a subset of VoIP contextual information relating to conversation context may correspond to the Call Contexts Class 910. The contextual information relating to conversation context may include information such as keywords supplied from a client, a service provider, a network, etc. The contextual information relating to conversation context may also include identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. In accordance with an illustrative embodiment, a Call Contexts Class 910 may be defined as a sub-tree structure of a VoIP Namespace 900, which includes nodes corresponding to file identification 912, supplied keyword 913, conversation keyword 914, frequency of use 915, subject of the conversation 916, and the like.

With reference to FIG. 12, a block diagram of a Device Type Class 920 is depicted. In one embodiment, a Device Type Class 920 may correspond to a subset of VoIP contextual information relating to a VoIP client device used for the conversation channel connection. The subset of the VoIP contextual information relating to the VoIP client device may include audio related information which may be needed to process audio data generated by the VoIP client device. The audio related information may include information related to the device's audio functionality and capability, such as sampling rate, machine type, output/input type, microphone, Digital Signal Processing (DSP) card information, or ability to present data items, and the like. The subset of the VoIP contextual information relating to the VoIP client device may include video related information which may be needed to process video data generated by the VoIP client device. The video related information may include resolution, refresh, type, and size of the video data, graphic card information, and the like. The contextual information relating to VoIP client devices may further include other device specific information such as a type of the computer system, processor information, network bandwidth, wireless/wired connection, portability of the computer system, processing settings of the computer system, and the like. In an illustrative embodiment, a Device Type Class 920 may be defined as a sub-tree structure of a VoIP Namespace 900, which includes nodes corresponding to Audio 922, Video 924, Device Specific 926, and the like.

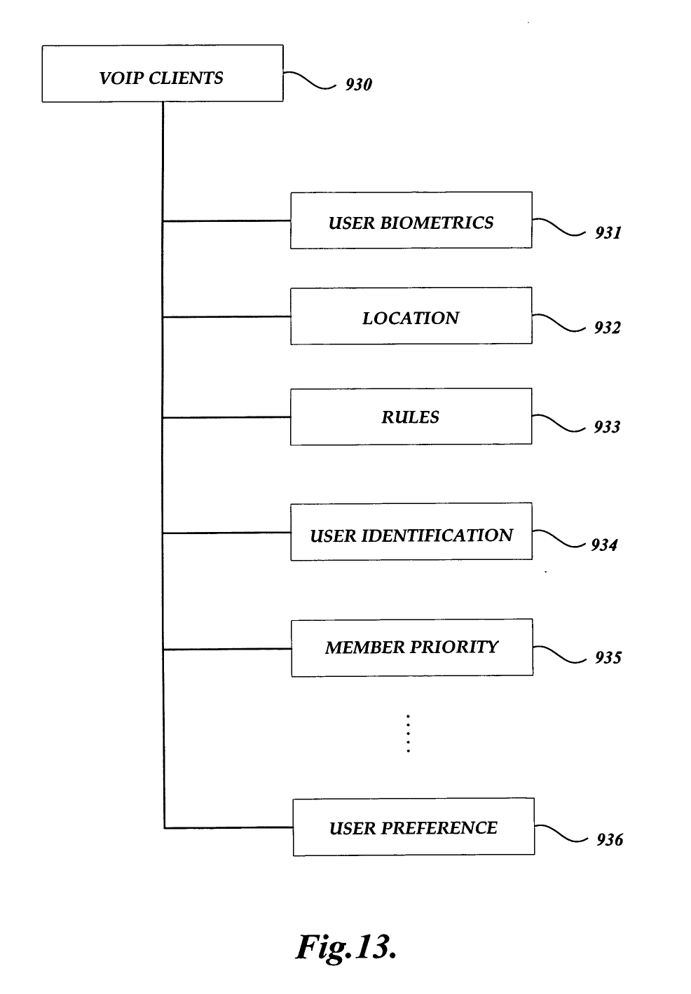

With reference to FIG. 13, a block diagram of a VoIP Client Class 930 is depicted. In accordance with an illustrative embodiment, a VoIP Client Class 930 may correspond to a subset of contextual information relating to VoIP clients. In one embodiment, the subset of the VoIP contextual information relating to the VoIP client may include voice profile information (e.g., a collection of information specifying the tonal and phonetic characteristics of an individual user), digital signature information, and biometric information. The biometric information can include user identification information (e.g., fingerprint) related to biometric authentication, user stress level, user mood, etc. Additionally, the subset of the VoIP contextual information relating to the VoIP client may include location information (including a client defined location, a VoIP defined location, a GPS/triangulation location, and a logical/virtual location of an individual user), assigned phone number, user contact information (such as name, address, company, and the like), rules defined by the client, a service provider, a network, etc., user rules and preferences, digital rights management (DRM), a member rank of an individual user in an organization, priority associated with the member rank, and the like. The priority associated with the member rank may be used to assign priority to the client for a conference call. In one embodiment, a VoIP Client Class 930 may be defined as a sub-tree structure of a VoIP Namespace 900, which includes nodes corresponding to user biometrics 931, location 932, rules 933, user identification 934, member priority 935, client preference 936, and the like.

While illustrative embodiments have been illustrated and described, it will be appreciated that various changes can be made therein without departing from the spirit and scope of the invention.

The embodiments of the invention in which an exclusive property or privilege is claimed are defined as follows:

1. In a digital voice communication environment that includes a sending client and a receiving client, a method of sending a data item over a communication channel from the sending client to the receiving client, the method comprising:
providing a control for generating a command to send the data item to the receiving client with call data;
in response to the control being activated:
obtaining event data that identifies the data item;
determining whether the data item may be accessed locally from the receiving client;
if the data item may be accessed locally from the receiving client, sending a request to present the data item without transmitting the data item to the receiving client; and
conversely, if the data item may not be accessed locally from the receiving client, sending the data item with a request to present the data item.

2. The method as recited in claim 1, wherein the control is configured to cause the data item to be transmitted automatically based on a rule established by the sending party.

3. The method as recited in claim 1, wherein the control is configured to cause the data item to be transmitted during a call.

4. The method as recited in claim 1, wherein the control is a software-based control accessible from an application program configured to initiate a call between the sending and receiving client.

5. The method as recited in claim 1, wherein the control causes an audio file to be multiplexed with conversation data being transmitted between the sending and receiving clients.

6. The method as recited in claim 1, wherein determining whether the data item may be accessed locally from the receiving client, includes:
receiving contextual information that describes the capabilities of the receiving client;
using the contextual information to identify packages of data items that are available from the receiving client.

7. The method as recited in claim 1, wherein the data item is a graphical representation that depicts a facial expression.

8. The method as recited in claim 7, wherein the graphical representation that depicts a facial expression is a smile, frown, or wink.

9. The method as recited in claim 1, wherein sending a request to present the data item includes embedding a tag into a data stream that identifies the data item.

10. The method as recited in claim 1, wherein sending the request with the data item includes assembling data packets that contain the data item as the payload.

11. The method as recited in claim 1, wherein the data item sent to the receiving client may be in a text, audio, image, or procedure-based data format.

12. A computer-readable medium containing computer-readable instructions which, when executed in a receiving client that receives a request to present a data item from a sending client, performs a method of presenting the data item, the method comprising:
parsing contextual information in the data stream obtained from the sending client to identify when the request to present the data item is received;
identifying preferences that describe the semantics of making the data item available on the receiving client; and
causing the data item to be presented on the receiving client in accordance with the identified preferences.

13. The computer-readable medium as recited in claim 12, further comprising allowing restrictions to be established for preventing the execution of instructions associated with the data item.

14. The computer-readable medium as recited in claim 13, wherein the restriction may be established by a privileged user.

15. The computer-readable medium as recited in claim 12, wherein identifying preferences that describe the semantics of making the data item available on the receiving client includes:
determining whether the receiving client is configured to present the data item; and
if the receiving client is not configured to present the data item, storing the data item at a network location accessible to a receiving party.

16. The computer-readable medium as recited in claim 12, wherein causing the data item to be presented on the receiving client includes:
determining whether the data item may be accessed locally;
if the data item may be accessed locally, recalling the data item; and
alternatively, if the data item may not be accessed locally, identifying the data item from a data stream received from the sending client.

17. The computer-readable medium as recited in claim 12, wherein causing the data item to be presented on the receiving client includes:
identifying an application program configured to present the data item;
launching the application program; and
using functionality provided by the application program to display the data item.

18. The computer-readable medium as recited in claim 12, wherein causing the data item to be presented on the receiving client includes issuing a procedure call to a program interface provided by the receiving client.

19. A computer-readable medium having computer executable components for sending a data item over a communication channel from a sending client to a receiving client, comprising:
a command handling component operative to:
obtain event data when a command to send a data item is received;
transmit a request to present the data item to the receiving client;
a processing component operative to:
identify when a request to present the data item is received from the sending client; and
cause the data item to be presented in accordance with the event data.

20. The computer-readable medium as recited in claim 19, further comprising an optimization component configured to:
determine whether the data item is locally available on the receiving client; and
if the data item is locally available, cause the data item to be presented on the receiving client without the data item being transmitted between the sending client and the receiving client.
